(19) United States
(12) Patent Application Publication
(10) Pub. No.: US 2013/0250798 A1
(43) Pub. Date: Sep. 26, 2013

(54) MOBILE COMMUNICATION METHOD, RADIO BASE STATION, AND MOBILE STATION

(71) Applicants: Mikio Iwamura, Tokyo (JP); Tetsushi Abe, Tokyo (JP)

(72) Inventors: Mikio Iwamura, Tokyo (JP); Tetsushi Abe, Tokyo (JP)

(73) Assignee: NTT DOCOMO, INC., Tokyo (JP)

(21) Appl. No.: 13/990,438

(22) PCT Filed: Nov. 28, 2011
(86) PCT No.: PCT/JP2011/077296

§ 371 Date: May 30, 2013

(51) Int. Cl. H04W 72/04

(52) U.S. Cl. CPC H04W 72/0446
USPC 370/252; 370/336

(57) ABSTRACT

A mobile communication method according to the present invention includes a step A of transmitting, by a mobile station UE#1 and a mobile station UE#2, information required for scheduling to a radio base station eNB, a step B of transmitting, by the radio base station eNB, scheduling information instructing to perform direct communication between the mobile station UE#1 and the mobile station UE#2 without passing through the radio base station eNB to the mobile station UE#1 and the mobile station UE#2 on the basis of the received information required for scheduling, and a step C of transmitting and receiving, by the mobile station UE#1 and the mobile station UE#2, data signals without passing through the radio base station eNB on the basis of the scheduling information.

### TECHNICAL FIELD

The present invention relates to a mobile communication method, a radio base station, and a mobile station.

### BACKGROUND ART

In a cellular mobile communication system such as a W-CDMA (Wideband-Code Division Multiple Access) scheme or an LTE (Long term Evolution) scheme, a plurality of mobile stations UE are configured to perform communication with each another through a radio access network device or a core network device.

### CITATION LIST

### Non Patent Literature

[NPL 1] 3GPP TS36.300 v10.0.0

### SUMMARY OF INVENTION

### Technical Problem

Unfortunately, in a conventional cellular mobile communication system, even when a plurality of mobile stations UE are located in the same cell (or a cell subordinate to a radio access network device), since it is configured such that both a data signal and a control signal are transmitted or received through the radio access network device, there is a problem in that a processing load of the radio access network device increases.

Accordingly, the present invention has been achieved in view of the above-described problem, and an object thereof is to provide a mobile communication method, a radio base station, and a mobile station with which it is possible to perform direct communication of a data signal between a plurality of mobile stations without passing through a radio access network.

### Solution to Problem

A first characteristic of the present invention is summarized in that a mobile communication method comprising: a step A of transmitting, by a first mobile station and a second mobile station, information required for scheduling to a radio base station; a step B of transmitting, by the radio base station, scheduling information instructing to perform direct communication between the first mobile station and the second mobile station without passing through the radio base station to the first mobile station and the second mobile station on the basis of the received information; and a step C of transmitting and receiving, by the first mobile station and the second mobile station, data signals without passing through the radio base station on the basis of the scheduling information.

A second characteristic of the present invention is summarized in that a radio base station comprising: a reception unit that receives information required for scheduling from a first mobile station and a second mobile station; a scheduling unit that performs a scheduling process on the basis of the received information; and a transmission unit that transmits scheduling information instructing to perform direct communication between the first mobile station and the second mobile station without passing through the radio base station to the first mobile station and the second mobile station.

A third characteristic of the present invention is summarized in that a mobile station comprising: a transmission unit that transmits information required for scheduling to a radio base station; and a control unit that transmits and receives data signals through traffic channels established between the mobile station and another mobile station when scheduling information instructing to perform direct communication with the other mobile station without passing through the radio base station is received from the radio base station.

### Advantageous Effects of Invention

As described above, according to the present invention, it is possible to provide a mobile communication method, a radio base station, and a mobile station with which it is possible to perform direct communication of a data signal between a plurality of mobile stations without passing through a radio access network.

### BRIEF DESCRIPTION OF DRAWINGS

FIG. 1 is a diagram illustrating the entire configuration of a mobile communication system according to a first embodiment of the present invention.

FIG. 2 is a functional block diagram of a radio base station according to the first embodiment of the present invention.

FIG. 3 is a functional block diagram of the mobile station according to the first embodiment of the present invention.

FIG. 4 is a sequence diagram illustrating operations in the mobile communication system according to the first embodiment of the present invention.

### DESCRIPTION OF EMBODIMENTS

### Mobile Communication System According to First Embodiment of the Present Invention

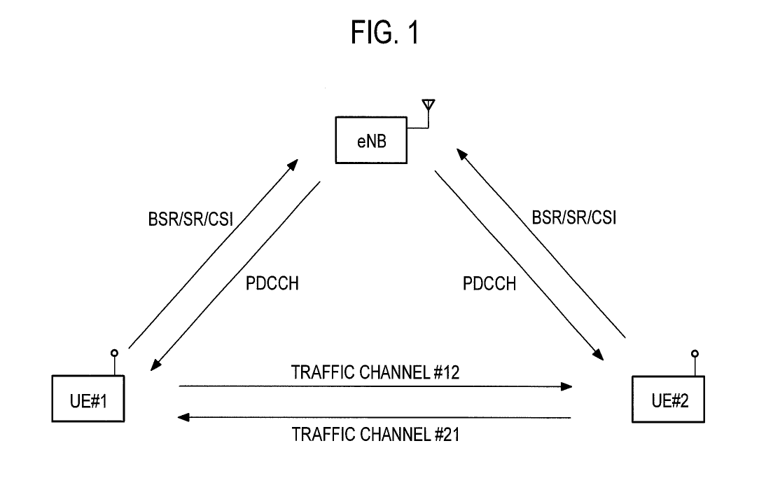

With reference to FIG. 1 to FIG. 4, a mobile communication system according to a first embodiment of the present invention will be described.

The mobile communication system according to the present embodiment is an LTE mobile communication system, and includes a radio base station eNB#1, and mobile stations UE#1/UE#2, as illustrated in FIG. 1. The present invention is also applicable to cellular mobile communication systems other than the LTE mobile communication system.

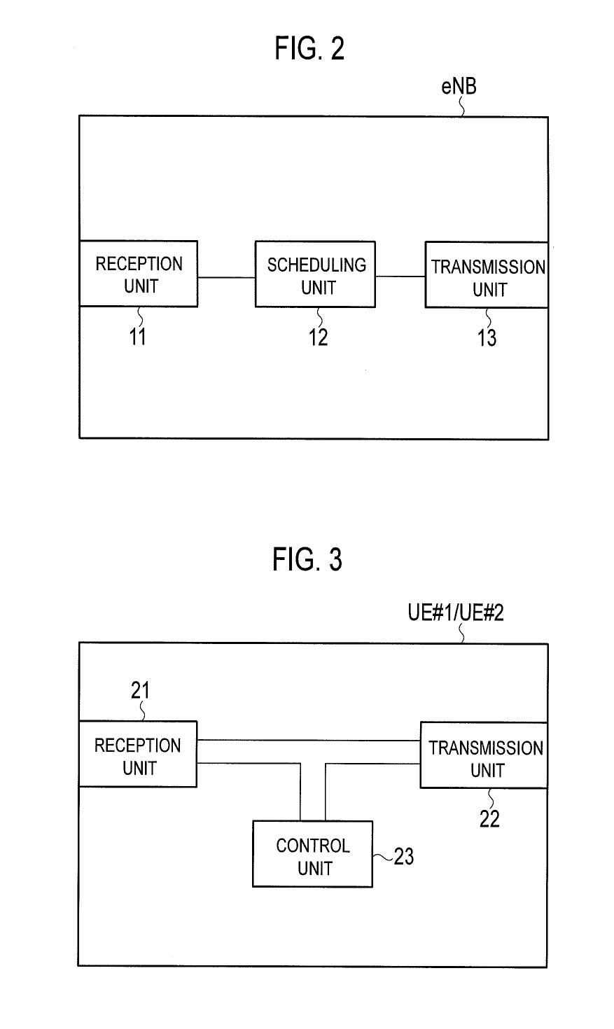

As illustrated in FIG. 2, the radio base station eNB includes a reception unit 11, a scheduling unit 12, and a transmission unit 13.

The reception unit 11 is configured to receive control signals, for example, information required for scheduling, transmitted from the mobile stations UE#1/UE#2 in a connected state in a cell subordinated to the radio base station eNB.

For example, the reception unit 11 may be configured to receive SR (Scheduling Request) of the mobile stations UE#1/UE#2, as the information required for scheduling.

Alternatively, the reception unit 11 may be configured to receive BSR (Buffer Status Report) indicating the statuses in buffers of the mobile stations UE#1/UE#2, as the information required for scheduling.

Otherwise, the reception unit 11 may be configured to receive CSI (Channel State Information) in traffic channels #12/#21 set between the mobile station UE#1 and the mobile station UE#2, as the information required for scheduling.

The CSI may include CQI (Channel Quality Indicator), RI (Rank Indicator), and PMI (Precoding Matrix Indicator), for example. The RI and the PMI are information for adaptively controlling MIMO (Multiple Input Multiple Output) transmission.

Specifically, the reception unit 11 may be configured to receive the CSI in the traffic channel #21 from the mobile station UE#1 and receive the CSI in the traffic channel #12 from the mobile station UE#2.

Here, the reception unit 11 may be configured to receive the BSR as a MAC (Media Access Control) signal and receive the SR and the CSI through PUCCH (Physical Uplink Control Channel).

The scheduling unit 12 is configured to perform a scheduling process for the mobile stations UE#1/UE#2 on the basis of the information required for scheduling received by the reception unit 11.

For example, the scheduling unit 12 may perform the scheduling process so as to allow the mobile station UE#1 to transmit the data signal to the mobile station UE#2 through the traffic channel #12 set between the mobile station UE#1 and the mobile station UE#2 at a predetermined timing (a subframe).

Alternatively, the scheduling unit 12 may perform the scheduling process so as to allow the mobile station UE#2 to transmit the data signal to the mobile station UE#1 through the traffic channel #21 set between the mobile station UE#1 and the mobile station UE#2 at a predetermined timing (a subframe).

The transmission unit 13 is configured to transmit the control signals, for example, the scheduling information, to the mobile stations UE#1/UE#2 through PDCCH (Physical Downlink Control Channel).

For example, the transmission unit 13 is configured to transmit, to the mobile stations UE#1/UE#2 through the PDCCH, scheduling information #12 indicating the mobile station UE#1 being able to transmit the data signal to the mobile station UE#2 through the traffic channel #12.

Alternatively, the transmission unit 13 is configured to transmit, to the mobile stations UE#1/UE#2 through the PDCCH, scheduling information #21 indicating the mobile station UE#2 being able to transmit the data signal to the mobile station UE#1 through the traffic channel #21.

Furthermore, the transmission unit 13 may be configured to add a bit indicating which one of the mobile stations UE#1 and UE#2 transmits (or receives) the data signal, to the scheduling information transmitted through the PDCCH.

Here, the transmission unit 13 may be configured to transmit the scheduling information #12/#21 to the mobile stations UE#1/UE#2 through PDCCH masked by using the same RNTI (Radio Network Temporary Identity).

The transmission unit 13 may designate the RNTI in advance using a control message (an RRC message) for the mobile stations UE#1/UE#2.

As illustrated in FIG. 3, the mobile stations UE#1/UE#2 each include a reception unit 21, a transmission unit 22, and a control unit 23.

The reception unit 21 is configured to receive the control signal, for example, the scheduling information, from the radio base station eNB through the PDCCH.

In addition, the reception unit 21 is configured to receive the data signal through the traffic channel #21 or #12 set between the other mobile station UE#2/UE#1 and the mobile station UE#1 or UE#2 on the basis of the scheduling information.

The transmission unit 22 is configured to transmit the control signal, for example, the BSR, the SR, or the CSI, to the radio base station eNB.

In addition, the transmission unit 22 is configured to transmit the data signal to the other mobile station UE#2/UE#12 through the traffic channel #21 or #12 set between the other mobile station UE#2/UE#1 and the mobile station UE#1 or UE#2.

The control unit 23 is configured to measure radio states in the traffic channels #21/#12 and calculate the CSI.

For example, the control unit 23 of the mobile station UE#1 is configured to measure the radio state in the traffic channel #21 and the control unit 23 of the mobile station UE#2 is configured to measure the radio state in the traffic channel #12.

Here, the control unit 23 is configured to calculate the CQI (Channel Quality Indicator), the RI (Rank Indicator), the PMI (Precoding Matrix Indicator), or the like, as the CSI.

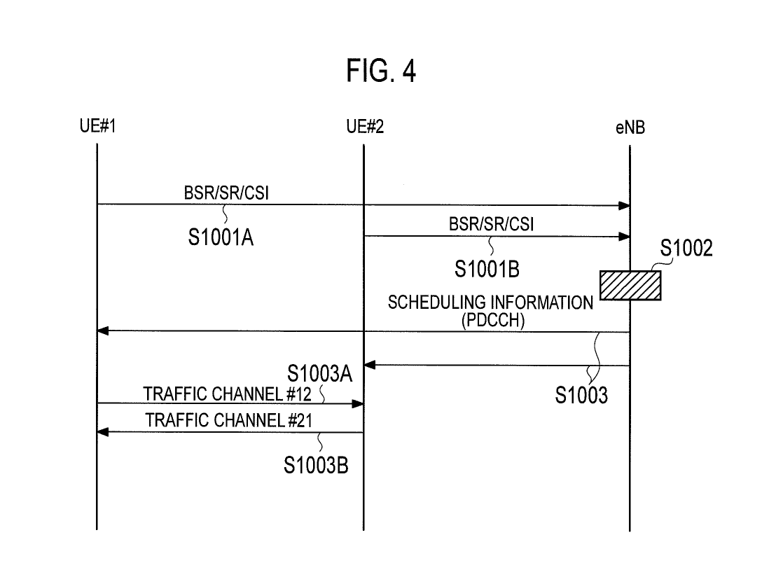

Hereinafter, with reference to FIG. 4, an example of the operation of the mobile communication system according to the first embodiment of the present invention will be described.

As illustrated in FIG. 4, in step S1001A, the mobile station UE#1 transmits the information required for scheduling such as the BSR, the SR, or the CSI to the radio base station eNB. In step S1001B, the mobile station UE#2 transmits the information required for scheduling such as the BSR, the SR, or the CSI to the radio base station eNB.

In step S1002, the radio base station eNB performs the scheduling process on the basis of the information required for scheduling acquired from the mobile stations UE#1/UE#2. In step S1003, the radio base station eNB transmits, to the mobile stations UE#1/UE#2 through the PDCCH, the scheduling information, for example, scheduling information indicating the mobile station UE#1 being able to transmit the data signal to the mobile station UE#2 through the traffic channel #12.

The mobile communication system according to the first embodiment of the present invention is configured such that the data signal is directly communicated between the mobile station UE#1 and the mobile station UE#2 without passing through the radio base station eNB, and thus, it is possible to reduce the processing load of the radio base station eNB in the cellular mobile communication system.

Further, the mobile communication system according to the first embodiment of the present invention is configured such that the control signal is transmitted from the mobile stations UE#1/UE#2 to the radio base station eNB, that is, the radio base station eNB is configured to perform the scheduling process for the direct communication between the mobile station UE#1 and the mobile station UE#2. Thus, a communication service provider that manages the radio base station eNB can comprehend information (for example, accounting information) about the direct communication.

The characteristics of the present embodiment as described above may be expressed as follows.

A first characteristic of the present embodiment is summarized as including: a step A of transmitting, by a mobile station UE#1 (a first mobile station) and a mobile station UE#2 (a second mobile station), the information required for scheduling to a radio base station eNB, a step B of transmitting, by the radio base station eNB, the scheduling information instructing to perform the direct communication between the mobile station UE#1 and the mobile station UE#2 without passing through the radio base station eNB to the mobile station UE#1 and the mobile station UE#2 on the basis of the received information required for scheduling, and a step C of transmitting and receiving, by the mobile station UE#1 and the mobile station UE#2, the data signals without passing through the radio base station eNB on the basis of the scheduling information.

In the first characteristic of the present embodiment, in the step A, the mobile station UE#1 and the mobile station UE#2 may transmit BSR (Buffer Status Report) indicating the statuses in the buffers of the mobile stations, as the information required for scheduling.

In the first characteristic of the present embodiment, in the step A, the mobile station UE#1 and the mobile station UE#2 may transmit SR (Scheduling Request), as the information required for scheduling.

In the first characteristic of the present embodiment, the mobile communication method may include a step of measuring, by the mobile station UE#1 and the mobile station UE#2, the radio states in the traffic channels for performing the direct communication, and, in the step A, the mobile station UE#1 and the mobile station UE#2 may transmit CSI (Channel State Information) indicating the measured radio states, as the information required for scheduling.

A second characteristic of the present embodiment is summarized in that a radio base station eNB includes a reception unit 11 that receives the information required for scheduling from a mobile station UE#1 and a mobile station UE#2, a scheduling unit 12 that performs the scheduling process on the basis of the received information required for scheduling, and a transmission unit 13 that transmits, to the mobile station UE#1 and the mobile station UE#2, the scheduling information instructing to perform the direct communication between the mobile station UE#1 and the mobile station UE#2 without passing through the radio base station eNB.

A third characteristic of the present embodiment is summarized in that mobile stations UE#1/UE#2 each include a transmission unit 22 that transmits the information required for scheduling to a radio base station eNB, and a transmission unit 21 and a reception unit 22 that transmits and receives the data signals through the traffic channels established between the mobile station UE#1 or UE#2 and the other mobile station UE#2/UE#1 when the scheduling information instructing to perform the direct communication with the other mobile station UE#2/UE#1 without passing through the radio base station eNB is received from the radio base station eNB.

In the third characteristic of the present embodiment, the transmission unit 22 may be configured to transmit BSR, as the information required for scheduling.

In the third characteristic of the present embodiment, the transmission unit 22 may be configured to transmit SR, as the information required for scheduling.

In the third characteristic of the present embodiment, the mobile stations may include a control unit (a measurement unit) 23 that measures the radio states in the traffic channels, and the transmission unit 22 may be configured to transmit CSI, as the information required for scheduling.

In addition, the operation of the above-mentioned radio base station eNB or mobile station UE #1/UE #2 may be implemented by hardware, may also be implemented by a software module executed by a processor, or may further be implemented by the combination of the both.

The software module may be arranged in a storage medium of an arbitrary format such as a RAM (Random Access Memory), a flash memory, a ROM (Read Only Memory), an EPROM (Erasable Programmable ROM), an EEPROM (Electronically Erasable and Programmable ROM), a register, a hard disk, a removable disk, or a CD-ROM.

The storage medium is connected to the processor so that the processor can write and read information into and from the storage medium. Such a storage medium may also be accumulated in the processor. Such a storage medium and processor may be arranged in an ASIC. The ASIC may be arranged in the radio base station eNB and the mobile station UE #1/UE #2. Furthermore, such a storage medium and processor may be arranged in the radio base station eNB and the mobile station UE #1/UE #2 as discrete components.

Thus, the present invention has been explained in detail by using the above-described embodiments; however, it is obvious that for persons skilled in the art, the present invention is not limited to the embodiments explained herein. The present invention can be implemented as a corrected and modified mode without departing the gist and the scope of the present invention defined by the claims. Therefore, the description of the specification is intended for explaining the example only and does not impose any limited meaning to the present invention.

### REFERENCE SIGNS LIST

eNB . . . Radio base station
UE . . . Mobile station
11, 21 . . . Reception unit
12 . . . Scheduling unit
13, 22 . . . Transmission unit
23 . . . Control unit

1. A mobile communication method comprising:
a step A of transmitting, by a first mobile station and a second mobile station, information required for scheduling to a radio base station;
a step B of transmitting, by the radio base station, scheduling information instructing to perform direct communication between the first mobile station and the second mobile station without passing through the radio base station to the first mobile station and the second mobile station on the basis of the received information; and
a step C of transmitting and receiving, by the first mobile station and the second mobile station, data signals without passing through the radio base station on the basis of the scheduling information.

2. The mobile communication method according to claim 1, wherein in the step A, the first mobile station and the second mobile station transmit, as the information, a buffer status report indicating statuses in buffers of the mobile stations.

3. The mobile communication method according to claim 1, wherein in the step A, the first mobile station and the second mobile station transmit scheduling request, as the information.

4. The mobile communication method according to claim 1, comprising:
a step of measuring, by each of the first mobile station and the second mobile station, radio states in traffic channels for performing the direct communication, wherein
in the step A, the first mobile station and the second mobile station transmit, as the information, channel state information indicating the measured radio states.

5. A radio base station comprising:
a reception unit that receives information required for scheduling from a first mobile station and a second mobile station;
a scheduling unit that performs a scheduling process on the basis of the received information; and
a transmission unit that transmits scheduling information instructing to perform direct communication between the first mobile station and the second mobile station without passing through the radio base station to the first mobile station and the second mobile station.

6. A mobile station comprising:
a transmission unit that transmits information required for scheduling to a radio base station; and
a control unit that transmits and receives data signals through traffic channels established between the mobile station and another mobile station when scheduling information instructing to perform direct communication with the other mobile station without passing through the radio base station is received from the radio base station.

7. The mobile station according to claim 6, wherein the transmission unit is configured to transmit, as the information, a buffer status report indicating a status in a buffer of the mobile station.

8. The mobile station according to claim 6, wherein the transmission unit is configured to transmit scheduling request, as the information.

9. The mobile station according to claim 6, comprising:
a measurement unit that measures a radio state in the traffic channel, wherein
the transmission unit is configured to transmit channel state information indicating the measured radio states, as the information.
